(19) United States
(12) Patent Application Publication
(10) Pub. No.: US 2015/0193915 A1
(43) Pub. Date: Jul. 9, 2015

(54) TECHNIQUE FOR PROJECTING AN IMAGE ONTO A SURFACE WITH A MOBILE DEVICE

(71) Applicant: NVIDIA CORPORATION, Santa Clara, CA (US)

(72) Inventor: Amol Babasaheb SHINDE, Pune (IN)

(73) Assignee: NVIDIA CORPORATION, Santa Clara, CA (US)

(21) Appl. No.: 14/148,466

(22) Filed: Jan. 6, 2014

(51) Int. Cl. G06T 5/00; G06F 1/16; H04N 9/31

(52) U.S. Cl. CPC G06T 5/006; H04N 9/3185; G06F 1/1639; G06F 2200/1637; G06T 2200/28; G06T 2207/10016; G06T 2207/20068

(57) ABSTRACT

A mobile device includes a projector configured to project images onto a target surface that resides within a projectable area. The mobile device identifies the target surface within the projectable area and then tracks that target surface as the mobile device is subject to different types of motion, including translation and rotation, among others. The mobile device then compensates for that motion when projecting the images, potentially eliminating distortion in the projected images. Additionally, the mobile device may compensate for geometric differences between the projected image and the target surface by cropping the images to fit within the target surface. One advantage of the disclosed technique is that the mobile device is capable of projecting images with reduced distortion despite movement associated with the mobile device.

### BACKGROUND OF THE INVENTION

1. Field of the Invention

Embodiments of the present invention relate generally to image projectors and, more specifically, to a technique for projecting an image onto a surface with a mobile device.

2. Description of the Related Art

A conventional projector is capable of projecting images and/or video onto a surface, such as a projection screen or a wall. When projection occurs, a conventional projector is typically placed on a stable surface, such as a table, in order to stabilize the projected images. A modern mobile device, such as a cell phone or tablet computer, may include a miniaturized projector that is similarly capable of projecting images and/or video.

However, one problem with this approach is that users of mobile devices oftentimes wish to hold those devices in their hands during operation, which may cause projected images to appear unsteady or distorted. In particular, a typical user cannot hold their hands perfectly steady, and may also wish to physically move around while holding the mobile device. Any such movements on the part of the user may destabilize the mobile device and, consequently, the projected images. As such, images projected from a mobile device may lack the steadiness and clarity normally associated with projected images.

Accordingly, what is needed in the art is a technique for reducing unsteadiness and/or distortion in images projected from a mobile device.

### SUMMARY OF THE INVENTION

One embodiment of the present invention sets forth a computer-implemented method for projecting an image onto a target surface, including identifying the target surface within a projectable area, generating a first image, determining one or more sources of distortion associated with the target surface, modifying the first image to compensate for the one or more sources of distortion to generate a second image, and projecting the second image onto the target surface, where the second image when projected onto the target surface is substantially similar to the first image.

One advantage of the disclosed technique is that the mobile device is capable of projecting images onto the target surface with reduced distortion despite movement associated with the mobile device.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a block diagram illustrating a computer system configured to implement one or more aspects of the present invention;

FIG. 2 is a block diagram of a parallel processing unit included in the parallel processing subsystem of FIG. 1, according to one embodiment of the present invention;

FIGS. 3A-3B illustrate block diagrams of a mobile device configured to identify a target surface and project an image onto the target surface, according to one embodiment of the present invention;

FIGS. 4A-4D illustrate exemplary scenarios in which the mobile device of FIGS. 3A-3B compensates for different environmental factors when projecting an image onto a target surface, according to various embodiments of the present invention;

FIG. 5 is a flow diagram of method steps for projecting an image onto a target surface with a mobile device, according to one embodiment of the present invention; and

FIG. 6 is a flow diagram of method steps for compensating for different environmental factors when projecting an image onto a target surface with a mobile device, according to one embodiment of the present invention.

### DETAILED DESCRIPTION

In the following description, numerous specific details are set forth to provide a more thorough understanding of the present invention. However, it will be apparent to one of skill in the art that the present invention may be practiced without one or more of these specific details.

### System Overview

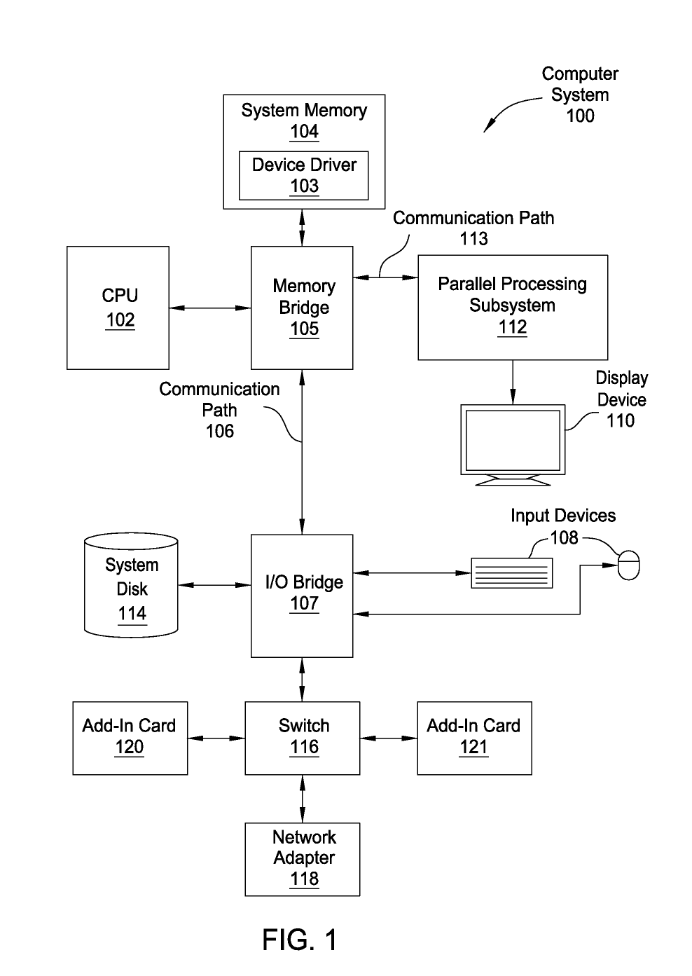

FIG. 1 is a block diagram illustrating a computer system 100 configured to implement one or more aspects of the present invention. As shown, computer system 100 includes, without limitation, a central processing unit (CPU) 102 and a system memory 104 coupled to a parallel processing subsystem 112 via a memory bridge 105 and a communication path 113. Memory bridge 105 is further coupled to an I/O (input/output) bridge 107 via a communication path 106, and I/O bridge 107 is, in turn, coupled to a switch 116.

In operation, I/O bridge 107 is configured to receive user input information from input devices 108, such as a keyboard or a mouse, and forward the input information to CPU 102 for processing via communication path 106 and memory bridge 105. Switch 116 is configured to provide connections between I/O bridge 107 and other components of the computer system 100, such as a network adapter 118 and various add-in cards 120 and 121.

As also shown, I/O bridge 107 is coupled to a system disk 114 that may be configured to store content and applications and data for use by CPU 102 and parallel processing subsystem 112. As a general matter, system disk 114 provides non-volatile storage for applications and data and may include fixed or removable hard disk drives, flash memory devices, and CD-ROM (compact disc read-only-memory), DVD-ROM (digital versatile disc-ROM), Blu-ray, HD-DVD (high definition DVD), or other magnetic, optical, or solid state storage devices. Finally, although not explicitly shown, other components, such as universal serial bus or other port connections, compact disc drives, digital versatile disc drives, film recording devices, and the like, may be connected to I/O bridge 107 as well.

In various embodiments, memory bridge 105 may be a Northbridge chip, and I/O bridge 107 may be a Southbridge chip. In addition, communication paths 106 and 113, as well as other communication paths within computer system 100, may be implemented using any technically suitable protocols, including, without limitation, AGP (Accelerated Graphics Port), HyperTransport, or any other bus or point-to-point communication protocol known in the art.

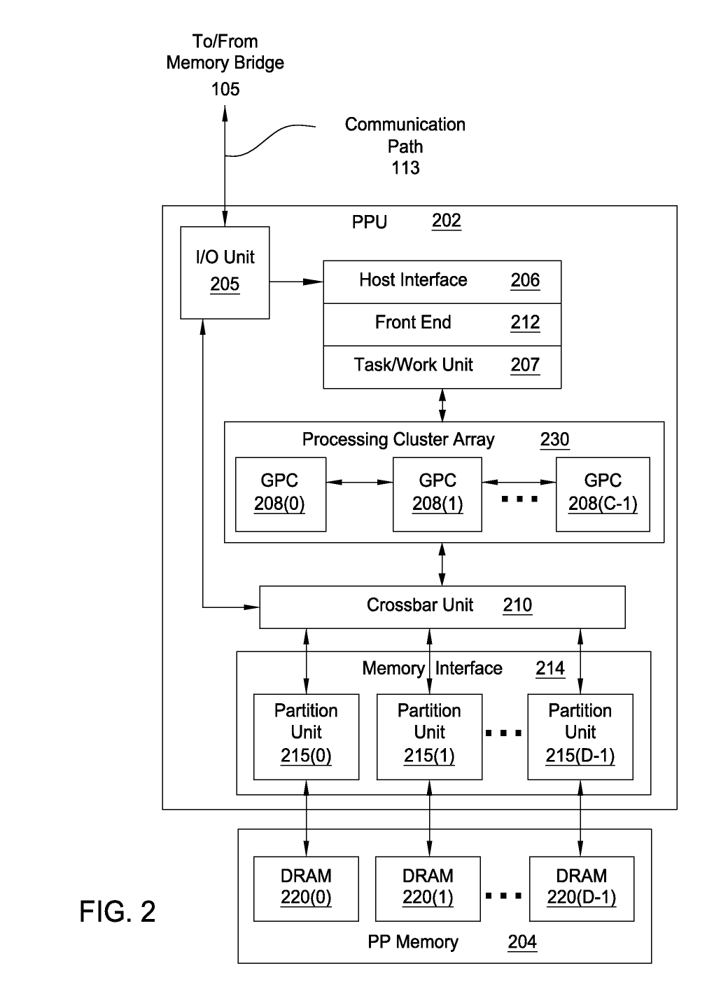

In some embodiments, parallel processing subsystem 112 comprises a graphics subsystem that delivers pixels to a display device 110 that may be any conventional cathode ray tube, liquid crystal display, light-emitting diode display, or the like. In such embodiments, the parallel processing subsystem 112 incorporates circuitry optimized for graphics and video processing, including, for example, video output circuitry. As described in greater detail below in FIG. 2, such circuitry may be incorporated across one or more parallel processing units (PPUs) included within parallel processing subsystem 112. In other embodiments, the parallel processing subsystem 112 incorporates circuitry optimized for general purpose and/or compute processing. Again, such circuitry may be incorporated across one or more PPUs included within parallel processing subsystem 112 that are configured to perform such general purpose and/or compute operations. In yet other embodiments, the one or more PPUs included within parallel processing subsystem 112 may be configured to perform graphics processing, general purpose processing, and compute processing operations. System memory 104 includes at least one device driver 103 configured to manage the processing operations of the one or more PPUs within parallel processing subsystem 112.

In various embodiments, parallel processing subsystem 112 may be integrated with one or more other the other elements of FIG. 1 to form a single system. For example, parallel processing subsystem 112 may be integrated with CPU 102 and other connection circuitry on a single chip to form a system on chip (SoC).

It will be appreciated that the system shown herein is illustrative and that variations and modifications are possible. The connection topology, including the number and arrangement of bridges, the number of CPUs 102, and the number of parallel processing subsystems 112, may be modified as desired. For example, in some embodiments, system memory 104 could be connected to CPU 102 directly rather than through memory bridge 105, and other devices would communicate with system memory 104 via memory bridge 105 and CPU 102. In other alternative topologies, parallel processing subsystem 112 may be connected to I/O bridge 107 or directly to CPU 102, rather than to memory bridge 105. In still other embodiments, I/O bridge 107 and memory bridge 105 may be integrated into a single chip instead of existing as one or more discrete devices. Lastly, in certain embodiments, one or more components shown in FIG. 1 may not be present. For example, switch 116 could be eliminated, and network adapter 118 and add-in cards 120, 121 would connect directly to I/O bridge 107.

FIG. 2 is a block diagram of a parallel processing unit (PPU) 202 included in the parallel processing subsystem 112 of FIG. 1, according to one embodiment of the present invention. Although FIG. 2 depicts one PPU 202, as indicated above, parallel processing subsystem 112 may include any number of PPUs 202. As shown, PPU 202 is coupled to a local parallel processing (PP) memory 204. PPU 202 and PP memory 204 may be implemented using one or more integrated circuit devices, such as programmable processors, application specific integrated circuits (ASICs), or memory devices, or in any other technically feasible fashion.

In some embodiments, PPU 202 comprises a graphics processing unit (GPU) that may be configured to implement a graphics rendering pipeline to perform various operations related to generating pixel data based on graphics data supplied by CPU 102 and/or system memory 104. When processing graphics data, PP memory 204 can be used as graphics memory that stores one or more conventional frame buffers and, if needed, one or more other render targets as well. Among other things, PP memory 204 may be used to store and update pixel data and deliver final pixel data or display frames to display device 110 for display. In some embodiments, PPU 202 also may be configured for general-purpose processing and compute operations.

In operation, CPU 102 is the master processor of computer system 100, controlling and coordinating operations of other system components. In particular, CPU 102 issues commands that control the operation of PPU 202. In some embodiments, CPU 102 writes a stream of commands for PPU 202 to a data structure (not explicitly shown in either FIG. 1 or FIG. 2) that may be located in system memory 104, PP memory 204, or another storage location accessible to both CPU 102 and PPU 202. A pointer to the data structure is written to a pushbuffer to initiate processing of the stream of commands in the data structure. The PPU 202 reads command streams from the pushbuffer and then executes commands asynchronously relative to the operation of CPU 102. In embodiments where multiple pushbuffers are generated, execution priorities may be specified for each pushbuffer by an application program via device driver 103 to control scheduling of the different pushbuffers.

As also shown, PPU 202 includes an I/O (input/output) unit 205 that communicates with the rest of computer system 100 via the communication path 113 and memory bridge 105. I/O unit 205 generates packets (or other signals) for transmission on communication path 113 and also receives all incoming packets (or other signals) from communication path 113, directing the incoming packets to appropriate components of PPU 202. For example, commands related to processing tasks may be directed to a host interface 206, while commands related to memory operations (e.g., reading from or writing to PP memory 204) may be directed to a crossbar unit 210. Host interface 206 reads each pushbuffer and transmits the command stream stored in the pushbuffer to a front end 212.

As mentioned above in conjunction with FIG. 1, the connection of PPU 202 to the rest of computer system 100 may be varied. In some embodiments, parallel processing subsystem 112, which includes at least one PPU 202, is implemented as an add-in card that can be inserted into an expansion slot of computer system 100. In other embodiments, PPU 202 can be integrated on a single chip with a bus bridge, such as memory bridge 105 or I/O bridge 107. Again, in still other embodiments, some or all of the elements of PPU 202 may be included along with CPU 102 in a single integrated circuit or system of chip (SoC).

In operation, front end 212 transmits processing tasks received from host interface 206 to a work distribution unit (not shown) within task/work unit 207. The work distribution unit receives pointers to processing tasks that are encoded as task metadata (TMD) and stored in memory. The pointers to TMDs are included in a command stream that is stored as a pushbuffer and received by the front end unit 212 from the host interface 206. Processing tasks that may be encoded as TMDs include indices associated with the data to be processed as well as state parameters and commands that define how the data is to be processed. For example, the state parameters and commands could define the program to be executed on the data. The task/work unit 207 receives tasks from the front end 212 and ensures that GPCs 208 are configured to a valid state before the processing task specified by each one of the TMDs is initiated. A priority may be specified for each TMD that is used to schedule the execution of the processing task. Processing tasks also may be received from the processing cluster array 230. Optionally, the TMD may include a parameter that controls whether the TMD is added to the head or the tail of a list of processing tasks (or to a list of pointers to the processing tasks), thereby providing another level of control over execution priority.

PPU 202 advantageously implements a highly parallel processing architecture based on a processing cluster array 230 that includes a set of C general processing clusters (GPCs) 208, where C≧1. Each GPC 208 is capable of executing a large number (e.g., hundreds or thousands) of threads concurrently, where each thread is an instance of a program. In various applications, different GPCs 208 may be allocated for processing different types of programs or for performing different types of computations. The allocation of GPCs 208 may vary depending on the workload arising for each type of program or computation.

Memory interface 214 includes a set of D of partition units 215, where D≧1. Each partition unit 215 is coupled to one or more dynamic random access memories (DRAMs) 220 residing within PPM memory 204. In one embodiment, the number of partition units 215 equals the number of DRAMs 220, and each partition unit 215 is coupled to a different DRAM 220. In other embodiments, the number of partition units 215 may be different than the number of DRAMs 220. Persons of ordinary skill in the art will appreciate that a DRAM 220 may be replaced with any other technically suitable storage device. In operation, various render targets, such as texture maps and frame buffers, may be stored across DRAMs 220, allowing partition units 215 to write portions of each render target in parallel to efficiently use the available bandwidth of PP memory 204.

A given GPCs 208 may process data to be written to any of the DRAMs 220 within PP memory 204. Crossbar unit 210 is configured to route the output of each GPC 208 to the input of any partition unit 215 or to any other GPC 208 for further processing. GPCs 208 communicate with memory interface 214 via crossbar unit 210 to read from or write to various DRAMs 220. In one embodiment, crossbar unit 210 has a connection to I/O unit 205, in addition to a connection to PP memory 204 via memory interface 214, thereby enabling the processing cores within the different GPCs 208 to communicate with system memory 104 or other memory not local to PPU 202. In the embodiment of FIG. 2, crossbar unit 210 is directly connected with I/O unit 205. In various embodiments, crossbar unit 210 may use virtual channels to separate traffic streams between the GPCs 208 and partition units 215.

Again, GPCs 208 can be programmed to execute processing tasks relating to a wide variety of applications, including, without limitation, linear and nonlinear data transforms, filtering of video and/or audio data, modeling operations (e.g., applying laws of physics to determine position, velocity and other attributes of objects), image rendering operations (e.g., tessellation shader, vertex shader, geometry shader, and/or pixel/fragment shader programs), general compute operations, etc. In operation, PPU 202 is configured to transfer data from system memory 104 and/or PP memory 204 to one or more on-chip memory units, process the data, and write result data back to system memory 104 and/or PP memory 204. The result data may then be accessed by other system components, including CPU 102, another PPU 202 within parallel processing subsystem 112, or another parallel processing subsystem 112 within computer system 100.

As noted above, any number of PPUs 202 may be included in a parallel processing subsystem 112. For example, multiple PPUs 202 may be provided on a single add-in card, or multiple add-in cards may be connected to communication path 113, or one or more of PPUs 202 may be integrated into a bridge chip. PPUs 202 in a multi-PPU system may be identical to or different from one another. For example, different PPUs 202 might have different numbers of processing cores and/or different amounts of PP memory 204. In implementations where multiple PPUs 202 are present, those PPUs may be operated in parallel to process data at a higher throughput than is possible with a single PPU 202. Systems incorporating one or more PPUs 202 may be implemented in a variety of configurations and form factors, including, without limitation, desktops, laptops, handheld personal computers or other handheld devices, servers, workstations, game consoles, embedded systems, and the like.

### Projecting an Image onto a Surface with a Mobile Device

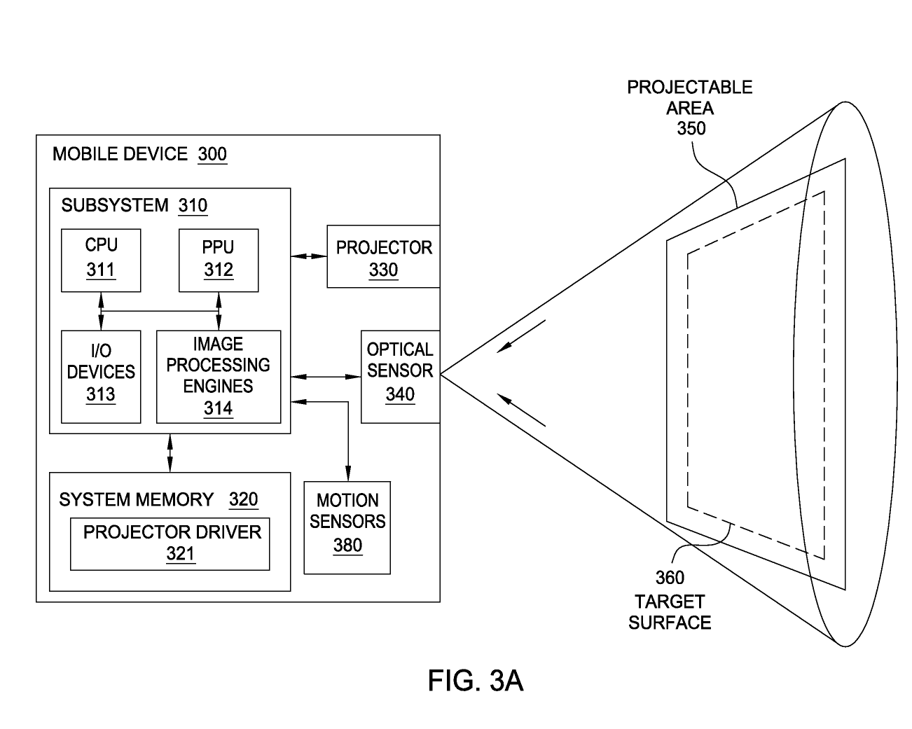

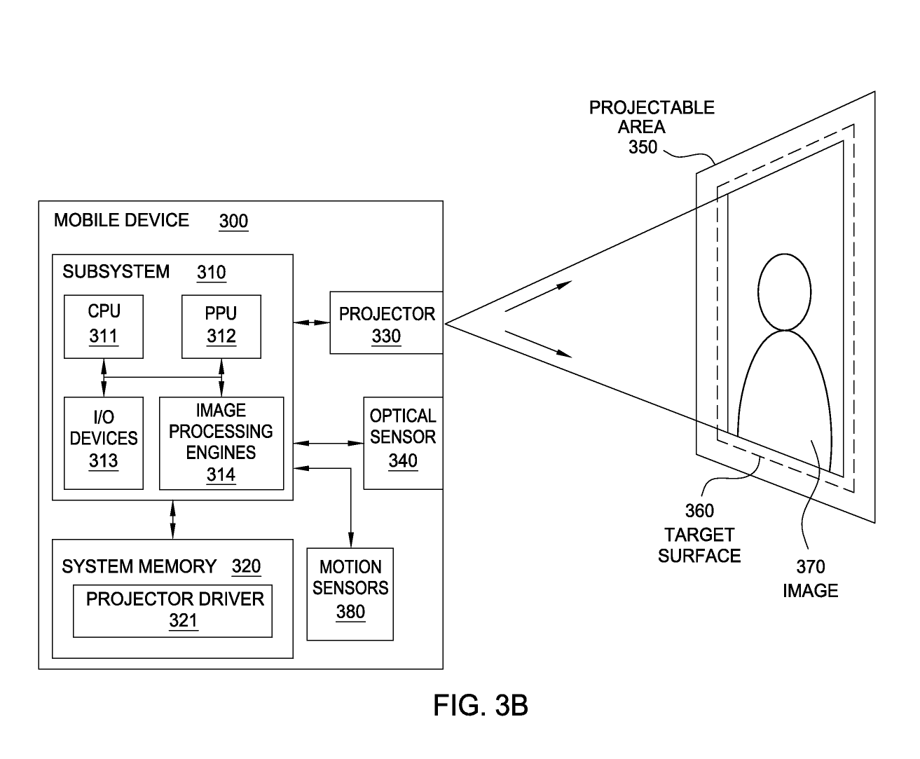

FIG. 3A illustrates a block diagram of a mobile device 300 configured to identify a target surface 360 and project an image onto that target surface, according to one embodiment of the present invention. Mobile device 300 may be a cell phone, a tablet computer, a laptop computer, or any other type of mobile computing platform. As shown, mobile device 300 includes a subsystem 310 coupled to a system memory 320, a projector 330, an optical sensor 340, and motion sensors 380. Subsystem 310 includes a central processing unit (CPU) 311, a parallel processing unit 312, input/output (I/O) devices 313, and one or more image processing engines 314, each coupled to one another. System memory 320 includes a projector driver 321.

CPU 311 is a processing unit configured to process data and to execute software applications, and may be substantially similar to CPU 102 of FIG. 1. PPU 312 is a multithreaded processor configured to execute multiple threads in parallel with one another, and may be substantially similar to PPU 202 of FIG. 2. I/O devices 313 include devices capable of receiving input, devices capable of generating output, and devices capable of both receiving input and generating output. Image processing engines 314 may include a wide variety of different hardware engines configured to process video, including video encoders, two-dimensional/three-dimensional (2D/3D) units, image signal processors (ISPs), and so forth.

System memory 320 may be any technically feasible memory unit, including a random-access memory (RAM) module, a hard disk, and so forth. System memory 320 may represent a portion of system memory 102 of FIG. 1, and projector driver 321 may be included within device driver 103 that resides within system memory 102 of FIG. 1. CPU 311 and PPU 312 are configured to execute device driver 321 in order to perform various functionality associated with subsystem 310, as described in greater detail below. Projector 330 is configured to project light that represents images or a series of images, such as, e.g., pictures or frames of video, respectively. Projector 330 may include various light-emitting diodes (LED) or other computer-controllable sources of light. Optical sensor 340 may be a video camera or other input device configured to measure a visual field proximate to mobile device 300. Optical sensor 340 is also configured to detect and measure images generated by projector 330 and/or various qualities of target surface 360.

Motion sensors 380 include different types of sensors configured to detect various types of motion to which mobile device 300 may be subjected. For example, motion sensors 380 may include a set of gyroscopes capable of detecting rotation and translation along different axes. In addition, motion sensors 380 could include a global positioning system (GPS) receiver capable of determining the position of mobile device 300 as that position changes over time. Generally, motion sensors 380 are configured to detect any kind of motion associated with mobile device 300.

In operation, subsystem 310 is configured to receive video data that reflects a projectable area 350 via optical sensor 340. Projectable area 350 represents a physical region where an image may be projected, such as, e.g., a wall, a screen, a shirt worn by a person, or any other flat or non-flat surface. Within that projectable area 350, subsystem 360 identifies target surface 360. Target surface 360 may be physical sub-region within projectable area 350 that could be demarcated, for example, by a physical border that surrounds target surface 360. Target surface 360 may also be a virtual sub-region within projectable area 350 that could be selected, for example, by a user of mobile device 300. In practice, CPU 311, PPU 312, and/or image processing engines 314 may implement computer vision techniques in order to identify target surface 360 and may rely on autofocus capabilities of optical sensor 340 to identify a depth associated with target surface 360. Once subsystem 310 identifies target surface 360, subsystem 310 then causes projector 330 to project an image onto that target surface 360, as described in greater detail below in conjunction with FIG. 3B.

FIG. 3B includes many of the same elements as FIG. 3A, including mobile device 300, projectable area 350, and target surface 360, as shown. As also shown, projector 330 is configured to project an image 370 onto target surface 360 within projectable area 350. As mentioned above, subsystem 310 is configured to identify target surface 360 from within projectable area 350 based on data gathered by optical sensor 340. Subsystem 310 then causes projector 330 to project image 370 onto target surface 360. In doing so, subsystem 310 may focus image 370 to appear clear on target surface 360 and/or scale image 370 to fit within a boundary of target surface 360. In addition, subsystem 310 is configured to dynamically track the position of target surface 360 relative to the position of mobile device 300. Subsystem 300 then modifies image 370 to compensate for various environmental factors that would otherwise distort image 370.

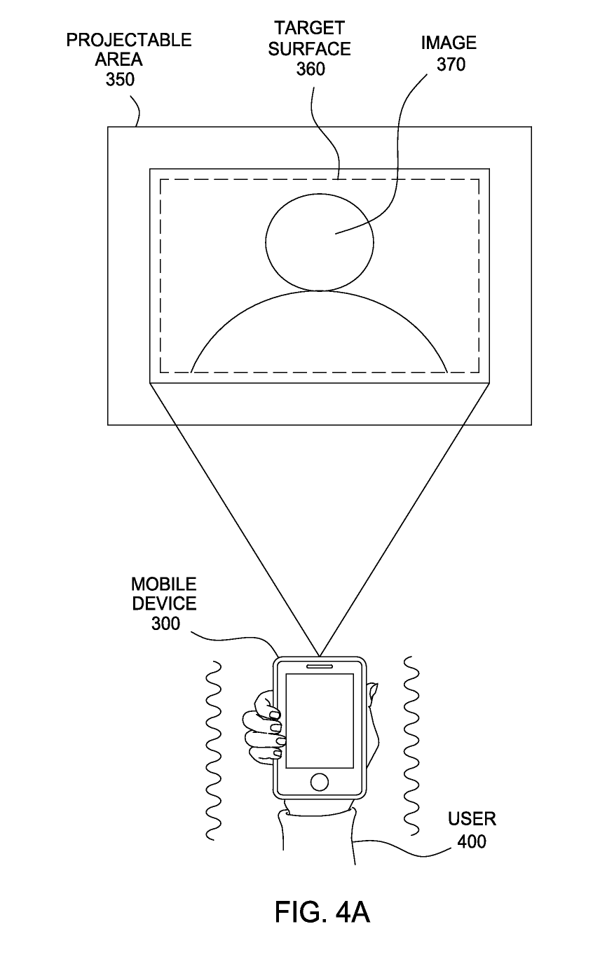

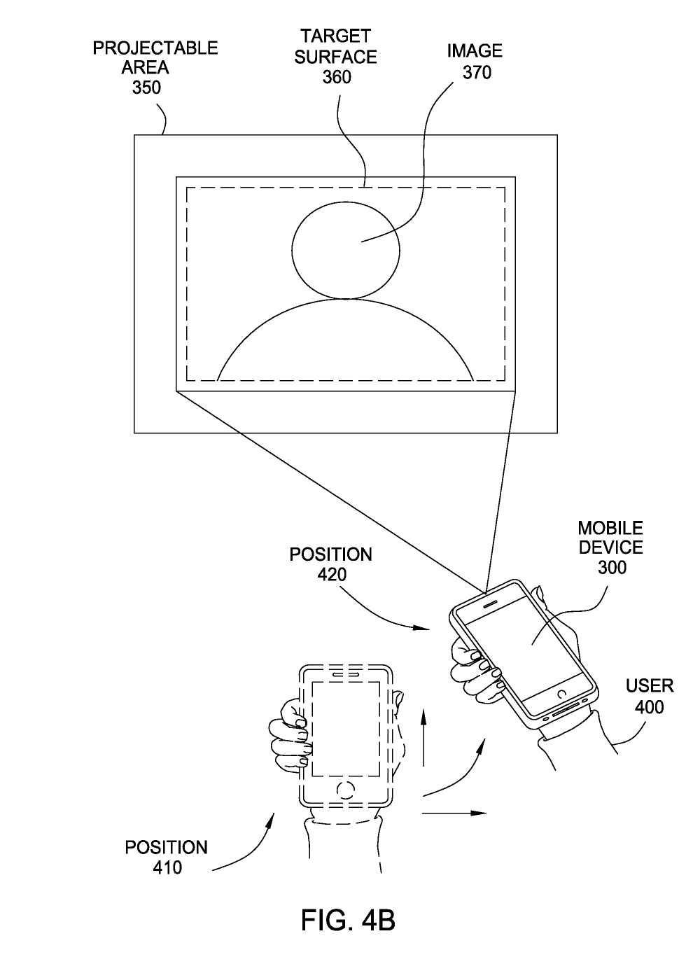

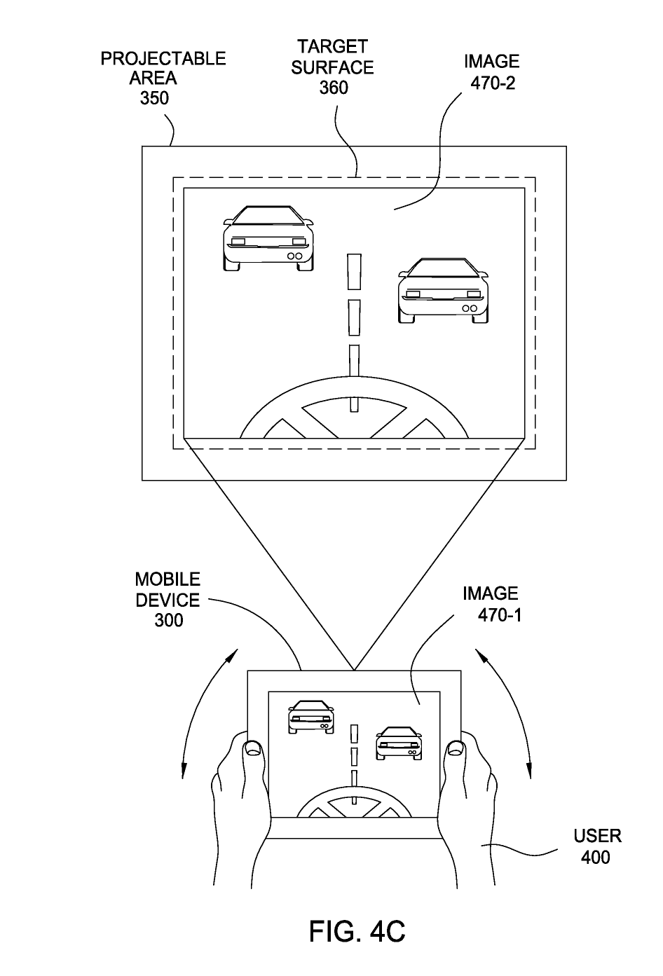

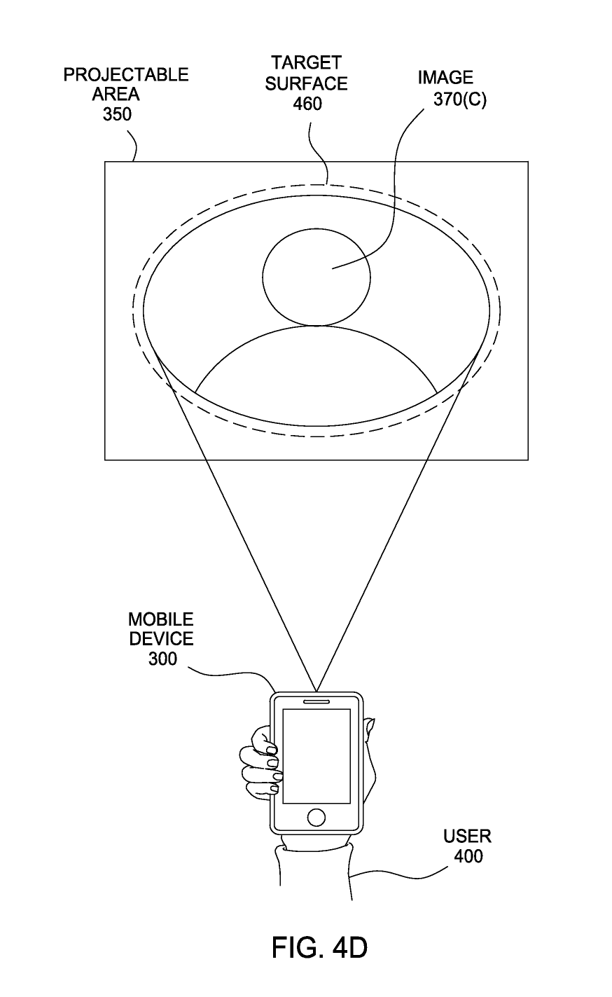

For example, image 370 could potentially become distorted due to relative motion between mobile device 300 and target surface 360 (without compensation provided by subsystem 310). Alternatively, image 370 could potentially become distorted when projected onto a target surface having a different shape compared to image 370 (again, without compensation provided by subsystem 310). However, subsystem 310 is configured to compensate for such environmental factors so that image 370 appears undistorted, as described below in conjunction with FIGS. 4A-4D.

FIG. 4A illustrates an exemplary scenario in which mobile device 300 of FIGS. 3A-3B compensates for unsteadiness when projecting image 370 onto target surface 360, according to one embodiment of the present invention. FIG. 4A illustrates many of the same elements shown in FIGS. 3A-3B, albeit from a different perspective. As also shown, a user 400 holds mobile device 300 during projection of image 370 with an unsteady grasp, which could potentially distort image 370 without proper compensation.

However, subsystem 310 is configured to detect that unsteadiness and to modify settings associated with projector 330 and/or properties of image 370 to eliminate unsteadiness from within image 370. Subsystem 310 may detect unsteadiness based on gyroscopic information provided by motion sensors 380 or other position-based information. In addition, subsystem 310 may identify that image 370 is moving relative to target surface 360 (e.g., due to motion of mobile device 300), and then take action to compensate for that movement. With the approach described herein, mobile device 300 is capable of projecting image 370 onto target surface 360 without propagating the unsteadiness introduced by user 400.

FIG. 4B illustrates an exemplary scenario in which the mobile device 300 of FIGS. 3A-3B compensates for different types of motion when projecting image 370 onto target surface 360, according to another embodiment of the present invention. FIG. 4B illustrates many of the same elements shown in FIGS. 3A-3B, albeit from a different perspective. As also shown, user 400 moves mobile device 300 from a position 410 to a position 420. In doing so, user 400 may translate, and/or rotate mobile device 300 relative to target surface 360, which could potentially distort image 370 without proper compensation.

However, subsystem 310 is configured to detect the motion of mobile device 300 from position 410 to position 420 and to modify settings associated with projector 330 and/or properties of image 370 to eliminate distortion effects caused by that motion from appearing within image 370. In doing so, subsystem 310 may eliminate skew caused by translation and/or rotation of mobile device 300, and may also adjust a direction that image 370 is projected to compensate for translation and/or rotation of mobile device 300. Subsystem 310 may detect the motion of mobile device 300 based on gyroscopic information provided by motion sensors 380 or other position-based information, as also discussed above. In addition, subsystem 310 may identify that image 370 is moving relative to target surface 360, and then take action to compensate for that movement.

Mobile device 300 may also determine that target surface 360 is moving relative to mobile device 300 based on changes in focus associated with target surface 360, an explicit depth measurement of target surface 360, and or other measurements of target surface 360. As such, subsystem 300 may also compensate for potential distortions in image 370 in situations where mobile device 300 is stationary, yet target surface 360 is not. With the various approaches described herein, mobile device 300 may be capable of projecting image 370 onto target surface 360 without distortion, despite relative motion between mobile device 300 and target surface 360.

FIG. 4C illustrates another exemplary scenario in which mobile device 300 of FIGS. 3A-3B compensates for rotation when projecting image 370 onto target surface 360 during video game play, according to one embodiment of the present invention. FIG. 4C illustrates many of the same elements shown in FIGS. 3A-3B, albeit from a different perspective. As also shown, mobile device 300 displays an image 470-1 on a display screen associated with mobile device 300. Image 470-1 may be associated with a video game that user 400 is currently playing. In the exemplary scenario described herein, the video game is a driving game, and user 400 interacts with that game by manipulating mobile device 300 in the fashion of a steering wheel. Mobile device 300 also projects an image 470-2 onto target surface 360 that is substantially similar to image 470-1. Given that user 400 may rotate mobile device 300 similarly to operating a steering wheel, image 470-2 could potentially become rotated relative to target surface 360 without proper compensation.

However, subsystem 310 is configured to detect that rotation and to modify settings associated with projector 330 and/or properties of image 470-2 to eliminate rotation associated with image 470-2. Subsystem 310 may detect rotation based on gyroscopic information provided by motion sensors 380 or other position-based information. Alternatively, subsystem 310 may identify that image 370 is rotating relative to target surface 360, and then take action to compensate for that rotation. With the approach described herein, mobile device 300 is capable of providing a motion-based interface to user 400 without allowing the associated motion to propagate to image 470-2.

FIG. 4D illustrates an exemplary scenario in which mobile device 300 of FIGS. 3A-3B compensates for an inconsistency between the shape of a target surface 460 and an image to be projected onto that target surface, according to one embodiment of the present invention. FIG. 4D illustrates many of the same elements shown in FIGS. 3A-3B, albeit from a different perspective. As also shown, projectable surface 350 includes an oval target surface 460. Since target surface 460 has a different shape than the rectangular image 370 shown in FIG. 3B, image 370 cannot easily be projected onto that target surface without the inconsistency between those two shapes causing some degree of distortion.

However, subsystem 310 is configured to detect the shape of target surface 460 and to project a cropped version of image 370, shown as image 370(C), onto target surface 460. Image 370(C) has an oval shape that is consistent with the oval shape of target surface 460. Persons skilled in the art will understand that subsystem 310 may detect a wide variety of different shapes associated with a target surface and then crop images to be projected accordingly. With the approach described herein, mobile device 300 is capable of causing any projected image to fit within a target surface having any shape, thereby avoiding distortion potentially caused by geometric inconsistencies between the image and the target surface.

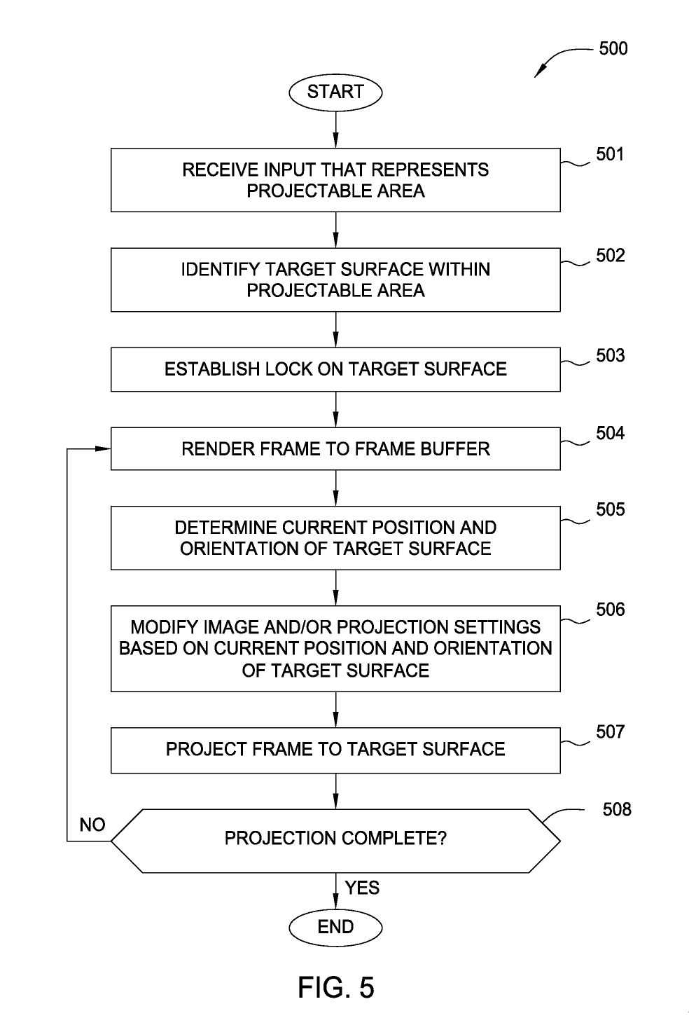

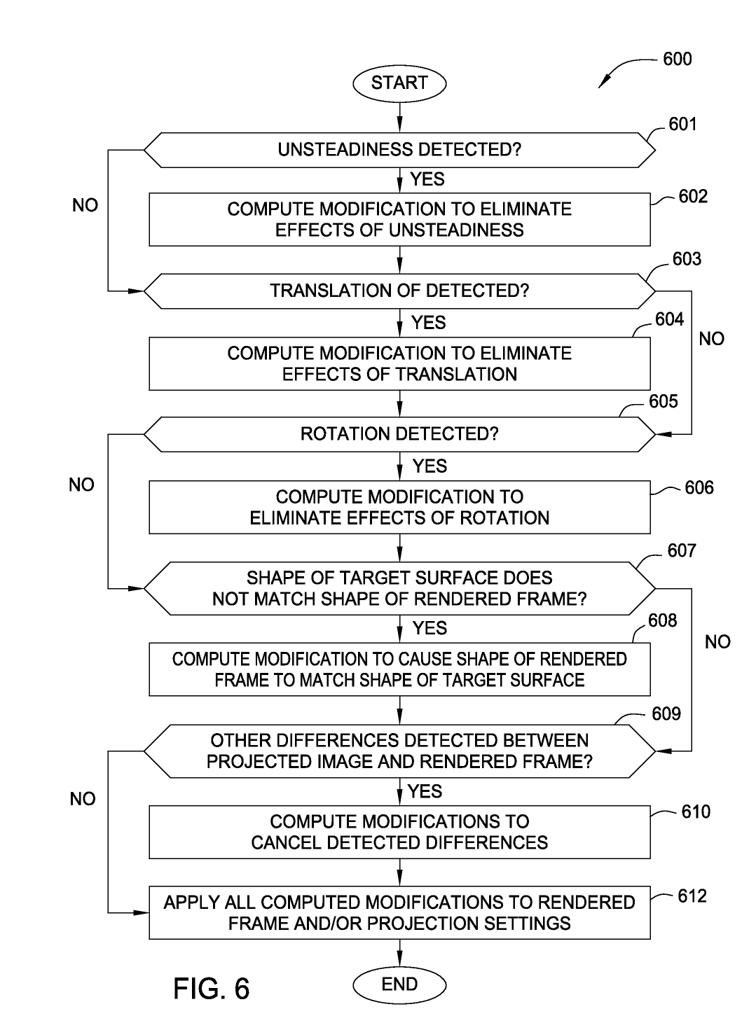

Referring generally to FIGS. 4A-4D, persons skilled in the art will recognize that the exemplary scenarios discussed in conjunction with those figures are provided for illustrative purposes only, and not meant to limit the scope of the invention in any way. As a general matter, subsystem 310 is configured to compensate for a wide variety of different factors that would otherwise disrupt the projection of an image onto a surface, including, but not limited to, the factors discussed above. In addition, subsystem 310 may account for lighting differences, texture differences, reflective variations, and other properties associated a with target surface, as well as different factors that could impact the effectiveness of mobile device 300 in projecting images. Subsystem 310 is also configured to perform some or all of the aforementioned techniques in conjunction with one another in order to simultaneously compensate for various different sources of distortion. The general functionality of subsystem 310 is discussed in stepwise fashion below in conjunction with FIG. 5. Specific compensation techniques that may be implemented by subsystem 310 are discussed in stepwise fashion below in conjunction with FIG. 6.

FIG. 5 is a flow diagram of method steps for projecting an image onto a target surface with a mobile device, according to one embodiment of the present invention. Although the method steps are described in conjunction with the systems of FIGS. 1-3B, persons skilled in the art will understand that any system configured to perform the method steps, in any order, is within the scope of the present invention.

As shown, a method 500 begins at step 501, where optical sensor 340 within subsystem 310 receives input that represents projectable area 350. At step 502, subsystem 310 identifies a target surface within projectable area 350. The target surface could be, e.g., target surface 360 of FIGS. 3A-4C or target surface 460 of FIG. 4D. At step 503, subsystem 310 establishes a lock on the target surface. In doing so, subsystem 310 may rely on gyroscopic sensors included within mobile device 300 to track the target surface relative to mobile device 300, or may also rely on computer vision techniques to optically track the target surface.

At step 504, subsystem 310 renders a frame of video data to a frame buffer. At step 505, subsystem 310 determines the current position and orientation of the target surface. Subsystem 310 generally determines the current position and orientation of the target surface relative to the current position and orientation of mobile device 300. As such, either mobile device 300 or the target surface could be in motion, although subsystem 310 is capable of determining the current position and orientation of the target surface in either case.

At step 506, subsystem 310 modifies an image and/or settings associated with projector 330 based on the current position and orientation of the target surface, thereby compensating for various factors that could potentially distort the image. Subsystem 310 could reduce unsteadiness in the image, rotate the image, translate the image, crop the image, or perform other such modifications to the image itself, or modify projector settings to accomplish similar effects. In one embodiment, subsystem 300 modifies the image and/or projection settings based on measurements of a previously projected image. Various techniques for modifying the image and/or projection settings are described in greater detail below in conjunction with FIG. 6.

At step 507, subsystem 310 causes projector 330 to project the image onto the target surface. At step 508, if subsystem 310 determines that the projection is not complete, then subsystem 310 returns to step 504 and proceeds as described above. Accordingly, subsystem 300 may repeat the method 500 for each frame of video data to be projected. Alternatively, subsystem 300 may repeat the method 500 for every Nth frame, N being a positive integer value. If subsystem 310 determines at step 508 that the projection is complete, then the method 500 ends.

FIG. 6 is a flow diagram of method steps for compensating for various environmental factors when projecting an image onto a target surface with a mobile device, according to one embodiment of the present invention. Although the method steps are described in conjunction with the systems of FIGS. 1-3B, persons skilled in the art will understand that any system configured to perform the method steps, in any order, is within the scope of the present invention.

As shown, a method 600 begins at step 601, where subsystem 310 determines whether unsteadiness is detected in mobile device 300 or within a projected image. If subsystem 310 detects unsteadiness at step 601, then at step 602, subsystem 310 computes modifications to a projected image and/or modifications to settings associated with projector 330 to eliminate the effects of that unsteadiness. Step 603 follows from either of steps 601 and 602.

At step 603, subsystem 310 determines whether translation is detected in mobile device 300 or within a projected image. If subsystem 310 detects translation at step 603, then at step 604, subsystem 310 computes modifications to a projected image and/or modifications to settings associated with projector 330 to eliminate the effects of that translation. Step 605 follows from either of steps 603 and 604.

At step 605, subsystem 310 determines whether rotation is detected in mobile device 300 or within a projected image. If subsystem 310 detects rotation at step 605, then at step 606, subsystem 310 computes modifications to a projected image and/or modifications to settings associated with projector 330 to eliminate the effects of that rotation. Step 607 follows from either of steps 605 and 606.

At step 607, subsystem 310 determines whether the shape of the target surface is inconsistent with the shape of the rendered frame or projected image. If subsystem 310 detects such an inconsistency, then at step 608, subsystem 310 computes modifications to cause the shape of the rendered frame or projected image to match the shape of the target surface. Subsystem 310 could re-render the frame or modify the amount of the existing frame that is projected, among other possibilities. Step 609 follows from either of steps 607 and 608.

At step 609, subsystem 310 determines whether other differences are detected between the projected image and the rendered frame. Subsystem 310 could detect those differences by measuring the projected image and comparing that image to the rendered frame from which the image was derived. Subsystem 310 could then identify differences that may have arisen during projection, including different types of distortion. If subsystem 310 detects any such differences at step 609, then at step 610, subsystem 310 computes modifications to the projected image and/or modifications to settings associated with projector 330 to cancel the effects of those differences. Step 612 follows from either of steps 609 and 610.

At step 612, subsystem 310 applies all computed modifications to the rendered frame and/or settings associated with projector 330. In doing so, subsystem 310 may modify an image that is already being projected, or may modify subsequently projected images. The method 600 then ends.

As with the method 500 discussed above in conjunction with FIG. 5, subsystem 310 may implement the method 600 repeatedly for each frame or every Nth frame to correct for environmental factors that would otherwise cause distortion in a projected image. With the approaches described herein, mobile device 300 may be used in a variety of different projection scenarios to project images with a quality consummate of that associated with traditional projectors.

In sum, a mobile device includes a projector configured to project images onto a target surface that resides within a projectable area. The mobile device identifies the target surface within the projectable area and then tracks that target surface as the mobile device is subject to different types of motion, including translation and rotation, among others. The mobile device then compensates for that motion when projecting the images, potentially eliminating distortion in the projected images. Additionally, the mobile device may compensate for geometric differences between the projected image and the target surface by cropping the images to fit within the target surface.

One advantage of the disclosed technique is that the mobile device is capable of projecting images with reduced distortion despite movement associated with the mobile device. As such, when the mobile device is held in the hand of a user during projection, any unsteadiness or motion introduced by the user may be mitigated.

One embodiment of the invention may be implemented as a program product for use with a computer system. The program(s) of the program product define functions of the embodiments (including the methods described herein) and can be contained on a variety of computer-readable storage media. Illustrative computer-readable storage media include, but are not limited to: (i) non-writable storage media (e.g., read-only memory devices within a computer such as compact disc read only memory (CD-ROM) disks readable by a CD-ROM drive, flash memory, read only memory (ROM) chips or any type of solid-state non-volatile semiconductor memory) on which information is permanently stored; and (ii) writable storage media (e.g., floppy disks within a diskette drive or hard-disk drive or any type of solid-state random-access semiconductor memory) on which alterable information is stored.

The invention has been described above with reference to specific embodiments. Persons of ordinary skill in the art, however, will understand that various modifications and changes may be made thereto without departing from the broader spirit and scope of the invention as set forth in the appended claims. The foregoing description and drawings are, accordingly, to be regarded in an illustrative rather than a restrictive sense.

Therefore, the scope of embodiments of the present invention is set forth in the claims that follow.

The invention claimed is:

1. A computer-implemented method for projecting an image onto a target surface, the method comprising:
identifying the target surface within a projectable area;
generating a first image;
determining one or more sources of distortion associated with the target surface;
modifying the first image to compensate for the one or more sources of distortion to generate a second image; and
projecting the second image onto the target surface, wherein the second image when projected onto the target surface is substantially similar to the first image.

2. The computer-implemented method of claim 1, wherein determining the one or more sources of distortion comprises identifying a change in position associated with the target surface.

3. The computer-implemented method of claim 2, wherein modifying the first image comprises changing a position associated with the first image based on the change in position associated with the target surface.

4. The computer-implemented method of claim 1, wherein determining the one or more sources of distortion comprises identifying a change in orientation associated with the target surface.

5. The computer-implemented method of claim 4, wherein modifying the first image comprises changing an orientation associated with the first image based on the change in orientation associated with the target surface.

6. The computer-implemented method of claim 1, wherein determining the one or more sources of distortion comprises identifying that the first image and the target surface have different shapes.

7. The computer-implemented method of claim 6, wherein modifying the first image comprises removing one or more portions of the image until the first image and the target surface have substantially similar shapes.

8. The computer-implemented method of claim 1, wherein the second image is projected from a mobile computing device.

9. The computer-implemented method of claim 8, wherein determining the one or more sources of distortion associated with the target surface comprises identifying dynamic properties associated with the mobile device relative to the target surface, and wherein modifying the first image comprises reducing effects of the dynamic properties from the first image to generate the second image.

10. A non-transitory computer-readable medium storing program instructions that, when executed by a processing unit, cause the processing unit to project an image onto a target surface, by performing the steps of:
identifying the target surface within a projectable area;
generating a first image;
determining one or more sources of distortion associated with the target surface;
modifying the first image to compensate for the one or more sources of distortion to generate a second image; and
projecting the second image onto the target surface, wherein the second image when projected onto the target surface is substantially similar to the first image.

11. The non-transitory computer-readable medium of claim 10, wherein the step of determining the one or more sources of distortion comprises identifying a change in position associated with the target surface.

12. The non-transitory computer-readable medium of claim 11, wherein the step of modifying the first image comprises changing a position associated with the first image based on the change in position associated with the target surface.

13. The non-transitory computer-readable medium of claim 10, wherein the step of determining the one or more sources of distortion comprises identifying a change in orientation associated with the target surface.

14. The non-transitory computer-readable medium of claim 13, wherein the step of modifying the first image comprises changing an orientation associated with the first image based on the change in orientation associated with the target surface.

15. The non-transitory computer-readable medium of claim 10, wherein the step of determining the one or more sources of distortion comprises identifying that the first image and the target surface have different shapes.

16. The non-transitory computer-readable medium of claim 15, wherein the step of modifying the first image comprises removing one or more portions of the image until the first image and the target surface have substantially similar shapes.

17. The non-transitory computer-readable medium of claim 10, wherein the second image is projected from a mobile computing device.

18. The non-transitory computer-readable medium of claim 17, wherein the step of determining the one or more sources of distortion associated with the target surface comprises identifying dynamic properties associated with the mobile device relative to the target surface, and wherein the step of modifying the first image comprises reducing effects of the dynamic properties from the first image to generate the second image.

19. A subsystem configured to project an image onto a target surface, including:
a processing unit configured to:
identify the target surface within a projectable area,
generate a first image,
determine one or more sources of distortion associated with the target surface,
modify the first image to compensate for the one or more sources of distortion to generate a second image, and
project the second image onto the target surface, wherein the second image when projected onto the target surface is substantially similar to the first image.

20. The subsystem of claim 19, further including:
a memory unit coupled to the processing unit and storing program instructions that, when executed by the processing unit, cause the processing unit to:
identify the target surface,
generate the first image,
determine the one or more sources of distortion,
modify the first image to generate the second image, and
project the second image onto the target surface.
